(19) United States
(12) Patent Application Publication
(10) Pub. No.: US 2025/0131056 A1
(43) Pub. Date: Apr. 24, 2025

(54) SYSTEMS, METHODS, AND PROGRAM FOR PRESENTING AN INTERVENTION FOR AN ERRONEOUS CAUSE OF BELIEF

(71) Applicant: Toyota Research Institute, Inc., Los Altos, CA (US)

(72) Inventors: Francine R. Chen, Menlo Park, CA (US); Totte Harinen, San Francisco, CA (US); Kenton Michael Lyons, Los Altos, CA (US); Alexandre L.S. Filipowicz, Mountain View, CA (US)

(73) Assignees: Toyota Research Institute, Inc., Los Altos, CA (US); Toyota Jidosha Kabushiki Kaisha, Toyota-shi (JP)

(21) Appl. No.: 18/382,783

(22) Filed: Oct. 23, 2023

(51) Int. Cl. G06F 16/9536; H04L 51/02

(52) U.S. Cl. CPC G06F 16/9536; G06Q 30/0201; G06Q 30/0203; G06Q 30/0255; H04L 51/02

(57) ABSTRACT

An apparatus for determining an erroneous cause for a belief and presenting interventions. The apparatus includes one or more memories comprising processor-executable instructions; and one or more processors configured to execute the processor-executable instructions and cause the apparatus to receive a communication through at least one of a direct method or indirect method, extract a target belief, identify an attributable cause based on the communication, compile known causes of the target belief and determine if the known cause is false, compare the attributable cause to the known causes and generate a score based on an amount of similarities, determine that the attributable cause corresponds to a known cause that is false, when the score is greater than a predetermined threshold, and generate interventions for presentation on the user interface device based on the determination that the attributable cause corresponds to the known cause that is false.

### TECHNICAL FIELD

The present specification generally relates to systems, methods, and program for generating interventions and, more specifically, systems and methods for receiving communications from an individual and providing interventions for erroneous causes of belief.

### BACKGROUND

People communicate vast amounts of information each and every day through various channels. These channels may include social media, email, messaging, voice calls and the like. Further, the use of chatbots in daily interactions has become increasingly common to provide personalized support and conversational interactions. During a person's daily interactions, they express beliefs, opinion, and perspectives on a variety of topics through these channels. People are exposed to vast amounts of information and often form beliefs based on incomplete or inaccurate information. As such, a person may act on false beliefs.

### SUMMARY

In one embodiment, an apparatus for determining an erroneous cause for a belief and presenting interventions via a user interface includes one or more memories and one more processors. The one or more memories include processor-executable instructions. The one or more processors execute the processor executable instructions. The one or more processors cause the apparatus to receive a communication through at least one of a direct method or indirect method, extract a target belief of the individual from the communication, identify an attributable cause for the target belief based on the communication, compile one or more known causes of the target belief and determine that at least one of the one or more known causes is false, generate a score for a comparison between the attributable cause and each of the one or more known causes, the score is based on an amount of similarities between the attributable cause and the one or more known causes, determine that the attributable cause corresponds to the at least one of the one or more known causes that is false, when the score is greater than a predetermined threshold, and generate interventions for presentation on the user interface based on the determination that the attributable cause corresponds to the at least one of the one or more known causes that is false.

In some embodiments, a method for determining an erroneous cause for a belief and presenting interventions via a user interface includes receiving a communication through one of a direct method or an indirect method, extracting a target belief from the communication, identifying an attributable cause for the target belief based on the communication, compiling one or more known causes of the target belief and determine that at least one of the one or more known causes is false, generating a score for a comparison between the attributable cause and each of the one or more known causes, the score is based on an amount of similarities between the attributable cause and the at least one of the one or more known causes, determining that the attributable cause corresponds to the at least one of the one or more known causes that is false, when the score is greater than a predetermined threshold, and generating interventions for presentation on the user interface based on the determination that the attributable cause corresponds to at least one of the one or more known causes that is false.

In some embodiments, a computer program product embodied on a computer-readable medium comprising logic for performing a method for determining an erroneous cause for a belief and presenting interventions via a user interface includes receiving a communication through at least one of a direct method or an indirect method, extracting a target belief from the communication, identifying an attributable cause for the target belief based on the communication, compiling one or more known causes of the target belief and determine that at least one of the one or more known causes is false, generating a score for a comparison between the attributable cause and each of the one or more known causes, the score is based on an amount of similarities between the attributable cause and the at least one of the one or more known causes determining that the attributable cause corresponds to the at least one of the one or more known causes that is false, when the score is greater than a predetermined threshold, and generating interventions for presentation on the user interface based on the determination that the attributable cause corresponds to the at least one or the one or more known causes that is false.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts components of a system for determining whether a person has an erroneous cause for a belief and presenting interventions to the person according to one or more embodiments shown and described herein;

FIG. 2 depicts an illustrative schematic of a server for determining whether a person has an erroneous cause for a belief and presenting interventions to the person according to one or more embodiments shown and described herein;

FIG. 3 depicts a flowchart of an example method for a presenting an intervention to the person, according to one or more embodiments shown and described herein;

FIG. 4 depicts an example of a user interface for communicating with the person, according to one or more embodiments shown and described herein; and

FIG. 5 depicts an example of a user interface for presenting an intervention, according to one or more embodiments shown and described herein.

### DETAILED DESCRIPTION

Embodiments of the present disclosure are directed to apparatuses, methods, and programs for receiving communications from an individual and generating interventions for erroneous causes of belief, though an advertisement, for example. In embodiments, the apparatuses may receive communications from an individual through at least one of a direct method or indirect method and extract a target belief of the individual from the communications. In embodiments, the apparatus may identify an attributable cause that the individual attributes to the target belief based on the communications. The apparatus may compile known causes of the target belief and determine if the known cause is false. The system may further compare the attributable cause to the known causes and generate a score based on an amount of similarities between the attributable cause and the known cause. In embodiments, the apparatus may determine a match if the score is greater than a predetermined threshold. Based on a determination of the match and the known cause as false, the apparatus may generate interventions to the individual through a user interface. Moreover, tailored interventions provide targeted and more focused interventions as opposed to larger general advertisements. The targeted interventions give more accurate information to users and generate a greater likelihood to change a user's mind. Moreover, as recommendations may be more targeted to a user's specific needs local processing power or memory needs may be reduced. These and additional benefits and features will be discussed in greater detail below.

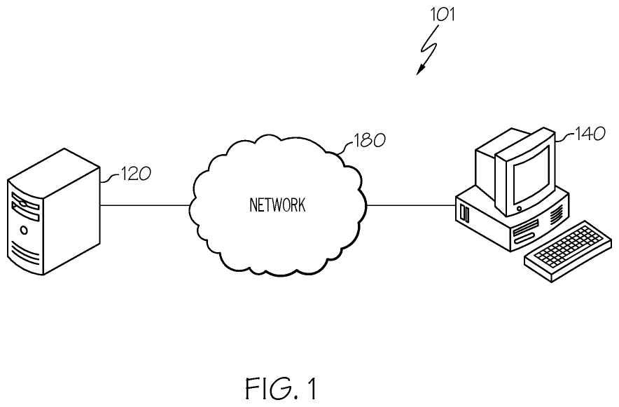

Referring now to FIG. 1, a system 101 for generating interventions to a user interface is schematically depicted. The system 101 may include a greater or fewer number of components than depicted without departing from the scope of the present disclosure. As illustrated in FIG. 1, the system can include a network 180, one or more user interface devices 140, and one or more apparatuses 120 such as a server or other computing device. The network 180 may include a wide area network, such as the internet, a local area network (LAN), a mobile communications network, a public service telephone network (PSTN) and/or other network and may be configured to electronically and/or communicatively connect the user interface device 140 and the apparatus 120.

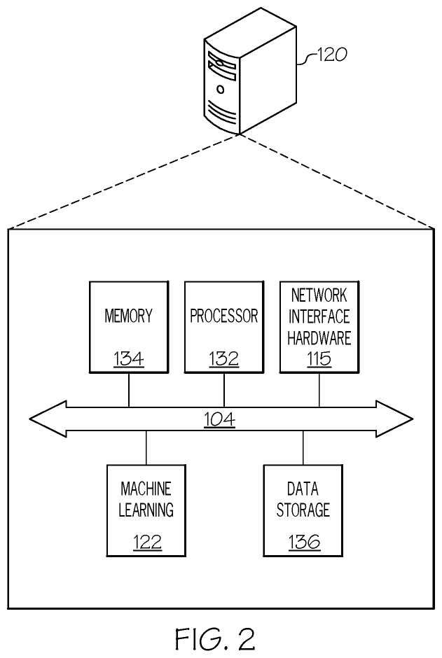

FIG. 2 depicts an example of an apparatus 120 configured to determine whether an individual has an erroneous cause for a belief and presenting interventions to the individual according. The apparatus 120 may include includes a communication path 104, one or more processors 132, one or more memory modules 134, network interface hardware 115, a machine learning model 122 and data storage 136. It is noted that while only one apparatus 120 is illustrated, in embodiments there may be multiple apparatuses 120 providing various information over the network 180 (e.g., as shown in FIG. 1).

The communication path 104 provides data interconnectivity between various modules disposed within the apparatus 120. Specifically, each of the modules can operate as a node that may send and/or receive data. In some embodiments, the communication path 104 includes a conductive material that permits the transmission of electrical data signals to processors, memories, sensors, and actuators throughout apparatus 120. In another embodiment, the communication path 104 can be a bus, such as, for example, a LIN bus, a CAN bus, a VAN bus, and the like. In further embodiments, the communication path 104 may be wireless and/or an optical waveguide. Components that are communicatively coupled may include components capable of exchanging data signals with one another such as, for example, electrical signals via conductive medium, electromagnetic signals via air, optical signals via optical waveguides, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The one or more processors 132 may be any device capable of executing machine-readable instructions stored on a non-transitory computer-readable medium, such as the one or more memory modules 134. Accordingly, the one or more processors 132 may include an electric controller, an integrated circuit, a microchip, a computer, or any other computing device. The one or more processors 132 may be communicatively coupled to the other components of the apparatus 120 by the communication path 104. Accordingly, the communication path 104 may communicatively couple any number of components with one another, and allow the components coupled to the communication path 104 to operate in a distributed computing environment. Specifically, each of the components may operate as a node that may send and/or receive data. While the embodiment depicted in FIG. 2 illustrates a single processor, other embodiments may include more than one processor.

The one or more memory modules 134 may be communicatively coupled to the one or more processors 132 over the communication path 104. The one or more memory modules 134 may be configured as volatile and/or nonvolatile memory and, as such, may include random access memory (includes SRAM, DRAM, and/or other types of RAM), flash memory secure digital (SD) memory, registers, compact discs (CD), digital versatile discs (DVD), and/or other types of non-transitory computer-readable mediums. Depending on the particular embodiment, these non-transitory computer-readable mediums may reside within the apparatus 120 and/or external to the apparatus 120, for example at the one or more servers. The one or more memory modules 134 may be configured to store one or more pieces of logic as described in more detail below. The embodiments described herein may utilize a distributed computing arrangement to perform any portion of the logic described herein. While the embodiment depicted in FIG. 2 illustrates a single memory module, other embodiments may include more than one memory module.

The network interface hardware 115 may be communicatively coupled to the one to more processors 132 over the communication path 104. The network interface hardware 115 may be any device capable of transmitting and/or receiving data via a network 180 (e.g., as shown in FIG. 1). Accordingly, network interface hardware 115 can include a communication transceiver for sending and/or receiving any wired or wireless communication. For example, the network interface hardware 115 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 115 includes hardware configured to operate in accordance with the Bluetooth wireless communication protocol. In another embodiment, the network interface hardware 115 may include a Bluetooth send/receive module for sending and receiving Bluetooth communications to/from a network 180.

The network interface hardware 115 allows the one or more processors 132 to communicate for example with an apparatus 120, such as any number of remote servers, and/or remote user devices (e.g., mobile devices, laptops, computers, etc.). The network 180 may include one or more computer networks (e.g., a personal area network, a local area network, or a wide area network), cellular networks, satellite networks and/or a global positioning system and combinations thereof. Accordingly, the one or more processors 132, the apparatus 120, and/or other components of the system 101 may be communicatively coupled to each other through the network 180 via wires or wireless technologies, via a wide area network, via a local area network, via a personal area network, via a cellular network, via a satellite network, or the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

Still referring to FIG. 2, the data storage 136 may reside local to and/or remote from the apparatus 120 and may be configured to store one or more pieces of data for access by the apparatus 120 and/or other components. The data storage 136 stores data related to direct communications, indirect communications, and causes of beliefs. Direct communications, for example, may be communications to a chat bot from a user, surveys submitted by a user, emails, responses, texts, verbal communications, text documents, or other direct communication submitted by a user to the system. In embodiments, a chat bot or chat robot may be logic executed by the one or more processors 132 that implements the machine-learning model 122 and is designed to simulate a conversation this the user. The chat bot may be implemented on various platforms including websites, applications, mobile app or the like. In embodiments, the chat bot is implemented on the user interface device 140.

Data from indirect communication includes any data from a user that is available from other indirect sources including blog posts, social media posts, social interactions, biographical information (e.g., age, gender, ethnicity, marital status etc.), browsing histories, financial information, communications to participating parties and the like. Further, indirect communication may be any communication from associated parties. In embodiments, indirect communication may be verbal or written communication. In other embodiments, the indirect communications may be any other forms of communication.

The data storage 136 stores data related to the causes of belief. The cause of belief is the reason or factors that contribute to the user adopting a particular belief or holding a certain conviction. Data related to the cause of belief may come from the user data. For example, this may include data related to the user's personal experiences, the user's culture and societal influences, education social interaction, and a user's personal authority. Data related to the cause of belief may also come from authoritative sources including authority webpages like government or institutions, professionals, journals, books, legal documents, publication abstracts, project summaries, proposals, patents, or other formats.

In embodiments, the apparatus 120 is configured to implement a machine-learning model 122. The machine-learning model 122 is a system that can learn from inputs and make predictions or decisions. Machine-learning models 122 are trained using a dataset. In embodiments, the machine-learning model 122 is configured to be trained using data transmitted through the network 180 to the apparatus 120 or otherwise stored at the apparatus 120, such as on the memory module 134. Data includes, but is not limited to, the data stored in the data storage 136. This data, for example, includes direct communications, indirect communications, and causes of beliefs. Further, training data may include user interactions with the user interface, including responses to interventions already made.

The machine-learning model 122 may be or include supervised learning models, unsupervised learning models, semi-supervised learning models, reinforcement learning models, deep learning models generative models, transfer learning models, neural networks or the like. In embodiments, the apparatus 120 is configured to use the machine-learning model 122 to input data and output interventions. It should be understood that this process may be completed by any processor including the one or more processors 132.

The machine-learning model 122 can be one of a variety of models and algorithms. The following list of models is merely an example. The machine-learning model 122 implemented in the present embodiments may be a supervised learning model, an unsupervised learning model, a semi-supervised learning model, a reinforcement learning model, a deep learning model, a generative model, an adversarial network, or the like.

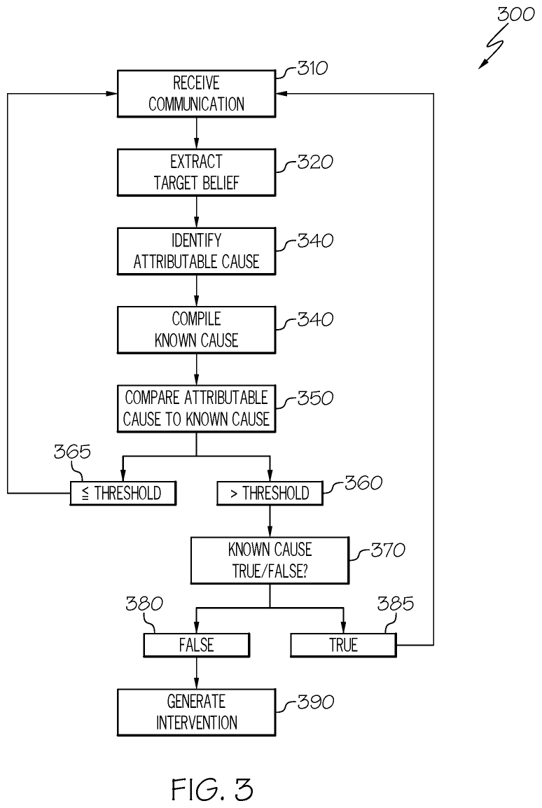

Now referring to FIG. 3, a flowchart 300 of an example method determining whether a communication includes an erroneous cause for a belief and presenting interventions is depicted. As described above, the method may be carried out by a processor 132 of the apparatus 120, a user interface device 140, or a combination of both. The flow chart depicted in FIG. 3 is a representation of a machine-readable instruction set stored in the one or more memory modules 134 and executed by the one or more processors 132. The process of the flowchart 300 in FIG. 3 may be executed at various times and in response to inputs or other signals from a user interface device 140 communicatively coupled to the apparatus 120.

In particular, at block 310, the logic executed by the one or more processors 132 cause the one or more processors 132 to receive one of a direct or an indirect communication from a user through the user interface device 140. In some embodiments, the apparatus 120 may receive this communication as a direct communication through a chat bot, email, survey, or other direct commination from the user to the apparatus 120, as described above. For example, the user may initiate a chat through the chat bot asking for information related to the purchase of a new vehicle or researching a medical condition. In other embodiment, for example, the user may respond to a survey requesting response on a specific topic.

In other embodiments, the apparatus 120 may receive the communication as an indirect communication, as described above, through analysis of an individual's blog posts, social media posts, social interactions, biographical information (e.g., age, gender, ethnicity, marital status etc.), browsing histories, financial information, communications to participating parties and the like. For example, a user may post a series of tweets reviewing various vehicles. As another example, a user may blog about a personal experience or opinion. In some embodiments, at block 310, the apparatus 120 stores the direct and indirect communications within the data storage 136.

At block 320, the logic executed by the one or more processors 132 cause the one or more processors 132 to extract a target belief from the direct or indirect communication received at block 310 above. In embodiments, the apparatus 120 may utilize the machine learning model 122 as describe above to extract the individual's target belief In other embodiments, the apparatus 120 may use natural language processing, sentiment analysis, named entity recognition, semantic analysis, or other module stored in the memory module 134 and executed by the one or more processors 132. In such embodiments, the apparatus 120 analyzes the individual's direct and indirect communications to generate the target belief of the individual. As a non-limiting example, the individual's communications may indicate a belief that electric vehicle are not a viable form of transportation.

At block 330, the logic executed by the one or more processors 132 cause the one or more processors 132 to identify an attributable cause that the individual attributes to the target belief based on the direct or indirect communications. The individual's cause of belief may be determines using the machine learning model 122, which may determine causes of belief based on similar user data, known causes, the direct and indirect communication, past communications, natural language processing, and other like language analysis. For example, a like user also indicated a belief that electric vehicles were not a viable form of transportation and indicated the cause was the user's belief of no chargers within a reasonable distance. The apparatus 120 may determine the current user's likely cause of belief is no chargers within a reasonable distance. In another example, the current user may indicate in indirect communications that he does not trust electric batteries. In this example, the apparatus 120 may determine the current user's likely cause of belief is a lack of trust in batteries.

At block 340, the logic executed by the one or more processors 132 cause the one or more processors 132 to compile a list of known causes of beliefs. Known causes of beliefs are the causes in the apparatus 120 available for comparison. The known causes of belief may come from various sources such as various publications, newspapers, websites, and the like. In some embodiments, the known causes of belief come from authoritative sources including authority webpages like government or institutions, professionals, journals, books, legal documents, publication abstracts, project summaries, proposals, patents, or other formats. As a non-limiting example, known causes of hesitation to purchase batteries include lack of available chargers, distance per charge, time per charge, cost, maintenance costs, battery degradation, or the like.

At block 350, the logic executed by the one or more processors 132 cause the one or more processors 132 to compare the attributable cause to the known causes and generate a score based on an amount of similarities between the attributable cause and the known causes. The score is compared against a threshold number. If the score is less than or equal to a threshold, at block 365, the apparatus 120 resets and returns to block 310 to receive additional communications from a user device. In some embodiments, the machine-learning model 122 is further trained with data from the attributable cause and the comparison between the known causes and the attributable causes. For example, the user gave information to a chatbot about a medical condition and the attributable cause was a severe medical reaction, however, the known causes were mild allergy. The generated score is below the threshold and the example method returns to block 310.

If the score is greater than a threshold, at block 360, the apparatus 120 moves to block 370 as described below. For example, it is determined our attributable cause is lack of available chargers. The attributable cause is compared against the known causes. Upon the known cause being lack of chargers, a score is generated above the threshold and the method moves to block 370.

At block 370, the logic executed by the one or more processors 132 cause the one or more processors 132 to determine if the known cause is false. As stated above, the source for known causes may be authoritative sources including authority webpages like government sources or institutions, professionals, journals, books, legal documents, publication abstracts, project summaries, proposals, patents, or other sources. In embodiments, the system 101 may use these authoritative sources to determine if the known cause is true at block 385 or false at block 380. If the known cause is true, the method returns to block 310. If the known cause is false, the method generates an intervention as shown below at block 390.

As a non-limiting example, the known cause if not enough public chargers within a certain distance. However, authoritative websites show there are X amount of suitable public chargers within close range of the individual's home. Therefore, the known cause is false and the apparatus 120 will generate an intervention. As another example, the known cause is a belief the individual has a rash due to an allergy. The known cause is true, therefore the method returns to block 310.

At block 390, the logic executed by the one or more processors 132 cause the one or more processors 132 to generate interventions to the individual through a user interface of a user interface device 140 upon a determination of the match and the known cause as false. In embodiments, individualized interventions are transmitted to the users to give accurate information in order to adjust to the individual's needs. For example, the attributable cause for not wishing to purchase an electric vehicle is a believe there are no public chargers, and the known cause of belief that there are no chargers is false, the intervention identifying local public chargers giving accurate information will produce an informed buyer.

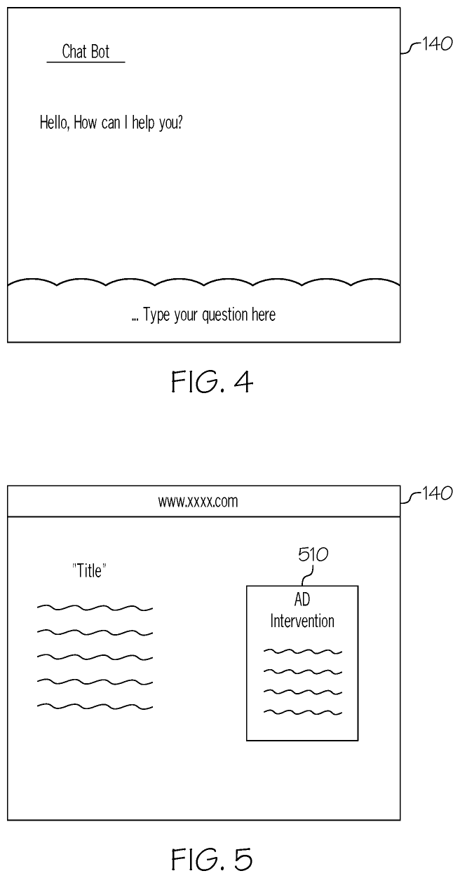

Now referring to FIG. 4, examples of a chatbot on a user interface device 140 is illustrated. In the illustrated embodiment, a direct communication from the individual to the apparatus 120 via a chatbot is depicted on the display. However, it should be understood that a chat bot is only one example an individual may interact with the apparatus 120. For example, the individual may use email, text, instant message, verbal, or other ways of communication. In embodiments, the chatbot may be used to complete survey tools. In some embodiments, the chatbot may be used to complete questionnaires including an individual's likelihood of buying an electric vehicle, the individual's beliefs about charging times and the availability of public charging stations. In embodiments, these interactions may be saved in the one or more memory modules 134 and data storage 136. Additionally, these interactions may be further used in training the machine-learning model 122. For example, input by the user may communicated to the machine-learning model 122 and used to improve or retrain the model to provide better more targeted recommendations.

Now referring to FIG. 5, examples of a user interface device 140 including a display with an intervention is illustrated. In the illustrated embodiment, the intervention is displayed as an advertisement 510 on a webpage. However, it should be understood that interventions are not limited to advertisements 510 on webpages, they may be included as communications via the chatbot or other direct or indirect communications sent through the system 101 to the individual.

It should now be understood that embodiments described herein are directed to systems, methods and computer programs for receiving communications from an individual and generating interventions for erroneous causes of belief, though an advertisement, for example. The system may receive communications from an individual through at least one of a direct method or indirect method and extract a target belief of the individual from the communications. The system may identify an attributable cause that the individual attributes to the target belief based on the communications. The system may compile known causes of the target belief and determine if the known cause is false. The system may further compare the attributable cause to the known causes and generate a score based on an amount of similarities between the attributable cause and the known cause. The system may determine a match if the score is greater than a predetermined threshold. Based on a determination of the match and the known cause as false, the system may generate interventions to the individual through a user interface. Moreover, tailored interventions provide targeted and focused interventions as opposed to larger general advertisements. These targeted interventions give accurate information to users and generate a greater likelihood to change a user's mind. Moreover, as recommendations may be more targeted to a user's specific needs, local processing power or memory needs may be reduced. These and additional benefits and features will be discussed in greater detail below.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An apparatus for determining an erroneous cause for a belief and presenting interventions via a user interface, the apparatus comprising one or more memories comprising processor-executable instructions; and one or more processors configured to execute the processor-executable instructions and cause the apparatus to:
receive a communication through at least one of a direct method or an indirect method;
extract a target belief from the communication;
identify an attributable cause for the target belief based on the communication;
compile one or more known causes of the target belief and determine that at least one of the one or more known causes is false;
generate a score for a comparison between the attributable cause and each of the one or more known causes, the score is based on an amount of similarities between the attributable cause and the one or more known causes;
determine that the attributable cause corresponds to the at least one of the one or more known causes that is false, when the score is greater than a predetermined threshold; and
generate the interventions for presentation on the user interface based on the determination that the attributable cause corresponds to the at least one of the one or more known causes that is false.

2. The apparatus of claim 1, wherein the user interface is an online chatbot.

3. The apparatus of claim 1, wherein the direct method is a survey tool.

4. The apparatus of claim 3, wherein the survey tool comprises a questionnaire including at least one of a likelihood of buying an electric vehicle, a belief about charging time, and an availability of public charging stations.

5. The apparatus of claim 1, wherein the target belief is extracted using a machine-learning model, and the machine-learning model is trained using training data comprising known sources and a plurality of communications.

6. The apparatus of claim 1, wherein the indirect method comprises using an analysis module that examines one or more communications.

7. The apparatus of claim 6, wherein the one or more communications examined by the analysis module comprise at least one of a social media post, a blog, a phone message, an email, or a recorded verbal communication.

8. The apparatus of claim 1, wherein the interventions are displayed through a web browser as an advertisement.

9. A method for determining an erroneous cause for a belief and presenting interventions via a user interface, the method comprising:
receiving a communication through one of a direct method or an indirect method,
extracting a target belief from the communication,
identifying an attributable cause for the target belief based on the communication,
compiling one or more known causes of the target belief and determine that at least one of the one or more known causes is false,
generating a score for a comparison between the attributable cause and each of the one or more known causes, the score is based on an amount of similarities between the attributable cause and the at least one of the one or more known causes,
determining that the attributable cause corresponds to the at least one of the one or more known causes that is false, when the score is greater than a predetermined threshold, and
generating the interventions for presentation on the user interface based on the determination that the attributable cause corresponds to at least one of the one or more known causes that is false.

10. The method of claim 9, wherein the user interface is an online chatbot.

11. The method of claim 9, wherein the direct method is a survey tool.

12. The method of claim 11, wherein the survey tool comprises a questionnaire including at least one of a likelihood of buying an electric vehicle, a belief about charging time, and an availability of public charging stations.

13. The method of claim 9, wherein the target belief is extracted using a machine-learning model, and the machine-learning model is trained using training data comprising known sources and a plurality of communications.

14. The method of claim 9, wherein the indirect method comprises using an analysis module that examines the communication.

15. The method of claim 14, wherein the communication examined by the analysis module comprises at least one of a social media post, a blog, a phone message, an email or a recorded verbal communication.

16. The method of claim 9, wherein the interventions are displayed through a web browser as an advertisement.

17. A computer program product embodied on a computer-readable medium comprising logic for performing a method for determining an erroneous cause for a belief and presenting interventions via a user interface, the method comprising:
receiving a communication through at least one of a direct method or an indirect method,
extracting a target belief from the communication,
identifying an attributable cause for the target belief based on the communication,
compiling one or more known causes of the target belief and determine that at least one of the one or more known causes is false,
generating a score for a comparison between the attributable cause and each of the one or more known causes, the score is based on an amount of similarities between the attributable cause and the at least one of the one or more known causes
determining that the attributable cause corresponds to the at least one of the one or more known causes that is false, when the score is greater than a predetermined threshold, and
generating the interventions for presentation on the user interface based on the determination that the attributable cause corresponds to the at least one or the one or more known causes that is false.

18. The computer program product of claim 17, wherein the target belief is extracted using a machine-learning model, the machine-learning model is trained using training data comprising known sources and a plurality of communications.

19. The computer program product of claim 17, wherein the indirect method comprises using an analysis module that examines one or more communications, the one or more communications comprising at least one of a social media post, a blog, a phone message, an email, or a recorded verbal communication.

20. The computer program product of claim 17, wherein the user interface is an online chatbot.
